(19) United States
(12) Patent Application Publication
(10) Pub. No.: US 2026/0309585 A1
(43) Pub. Date: Oct. 8, 2026

(54) SYSTEM AND METHOD FOR DIAGNOSING A SUSPENSION

(71) Applicant: GM GLOBAL TECHNOLOGY OPERATIONS LLC, Detroit, MI (US)

(72) Inventors: Robert A. Short, Holly, MI (US); Michael P. Kirbitz, Holly, MI (US); James D. Patton, Brighton, MI (US); Brian K. Saylor, South Lyon, MI (US); Eric B. Hoyer, White Lake, MI (US)

(73) Assignee: GM GLOBAL TECHNOLOGY OPERATIONS LLC, Detroit, MI (US)

(21) Appl. No.: 19/173,083

(22) Filed: Apr. 8, 2025

(51) Int. Cl. G01M 17/04; B60G 99/00

(52) U.S. Cl. CPC G01M 17/04; B60G 99/00; B60G 2400/104; B60G 2400/252; B60G 2400/90

(57) ABSTRACT

A method of diagnosing a vehicle suspension includes applying a first force sequence across a first axle suspension and measuring a first response of the first axle suspension with at least one sensor on the vehicle to the first force sequence. The method also includes applying a second force sequence across the first axle suspension, measuring a second response of the first axle suspension with the at least one sensor on the vehicle to the second force sequence, and measuring a dynamic response of the first axle suspension when one of the first force sequence or the second force sequence is released. The method further includes determining a status of the first axle suspension based on at least one of the first response, the second response, or the dynamic response.

### BACKGROUND

The present disclosure relates generally to vehicle suspension diagnostic systems and methods. More particularly, the disclosure relates to an integrated system and method for performing comprehensive diagnostics on vehicle suspension systems.

Diagnosing suspension issues on a vehicle generally includes a mechanic taking the vehicle on a test drive to identify the suspension issue by identifying the issue by sound or vehicle feedback when encountering obstacles. However, it can be difficult to reproduce some noises or vehicle responses that the owner of the vehicle has reported. This can result in misdiagnosis or the replacement of unnecessary components.

### SUMMARY

Disclosed herein is a method of diagnosing a suspension on a vehicle. The method includes applying a first force sequence across a first axle suspension and measuring, with at least one sensor on the vehicle, a first response of the first axle suspension to the first force sequence. The method also includes applying a second force sequence across the first axle suspension, measuring a second response of the first axle suspension to the second force sequence with the at least one sensor on the vehicle, and measuring a dynamic response of the first axle suspension when one of the first force sequence or the second force sequence is released. The method further includes determining a status of the first axle suspension based on at least one of the first response, the second response, or the dynamic response.

In one aspect of the disclosure the first force sequence is applied utilizing an active roll bar applying a first pair of opposing forces to the first axle suspension in a first pair of rotational directions.

In one aspect of the disclosure the second force sequence is applied utilizing the active roll bar applying a second pair of opposing forces to the first axle suspension in a second pair of rotational directions opposite the first pair of rotational directions.

In one aspect of the disclosure the active roll bar includes a drive motor configured to rotate a first portion of the active roll bar independently of a second portion of the active roll bar.

In one aspect of the disclosure the first portion of the active roll bar is mechanically connected to a first suspension corner of the first axle suspension with a first end link and the second portion of the active roll bar is connected to a second corner of the first axle suspension with a second end link.

In one aspect of the disclosure the first force sequence and the second force sequence are applied utilizing a first pair of hydraulic actuators each mechanically connected to opposing corners of the first axle suspension.

In one aspect of the disclosure the dynamic response includes a first dynamic response when the first force sequence is released and a second dynamic response when the second force sequence is released.

In one aspect of the disclosure the at least one sensor includes a pair of ride height sensors configured to measure suspension travel on at opposing corners of the first axle suspension.

In one aspect of the disclosure the method includes identifying a broken end link when suspension travel measured with the at least one sensor is less than a predetermined suspension travel.

In one aspect of the disclosure the at least one sensor includes an inertial measurement unit configured to measure a roll angle of the vehicle and a lateral acceleration of the vehicle.

In one aspect of the disclosure the method includes identifying a worn damper when the lateral acceleration damping of the vehicle is below a predetermined damping threshold.

In one aspect of the disclosure the status is determined to be a non-functioning suspension component when a lateral acceleration peak exceeds a predetermined lateral acceleration threshold peak.

Disclosed herein is a non-transitory computer-readable storage medium embodying programmed instructions which, when executed by a processor, are operable for performing a method. The method includes applying a first force sequence across a first axle suspension on a vehicle and measuring a first response of the first axle suspension to the first force sequence using at least one sensor on the vehicle. The method also includes applying a second force sequence across the first axle suspension, measuring a second response of the first axle suspension to the second force sequence using the at least one sensor on the vehicle, and measuring a dynamic response of the first axle suspension when one of the first force sequence or the second force sequence is released. The method further includes determining a status of the first axle suspension based on at least one of the first response, the second response, or the dynamic response.

Disclosed herein is a vehicle. The vehicle includes a body defining a passenger cabin, a first suspension corresponding to a first axle and configured to support the body, a second suspension corresponding to a second axle and configured to support the body, a first suspension actuator associated with the first axle, a second suspension actuator associated with the second axle, and at least one sensor configured to measure movement of the first axle, the second axle, or the body. The vehicle also includes a controller in communication with the first suspension actuator, the second suspension actuator, and the at least one sensor. The controller is configured to apply a first force sequence across a first axle suspension and measure a first response of the first axle suspension to the first force sequence using at least one sensor on the vehicle. The controller is also configured to apply a second force sequence across the first axle suspension, measure a second response of the first axle suspension to the second force sequence using the at least one sensor on the vehicle, and measure a dynamic response of the first axle suspension when one of the first force sequence or the second force sequence is released. The controller is further configured to determine a status of the first axle suspension based on at least one of the first response, the second response, or the dynamic response.

### BRIEF DESCRIPTION OF THE DRAWINGS

The accompanying drawings, which are incorporated into and constitute a part of this specification, illustrate implementations of the disclosure and, together with the description, explain the principles of the disclosure.

FIG. 1 schematically illustrates a vehicle having a system for performing vehicle suspension diagnosis.

FIG. 2 is a flow diagram of a method of performing vehicle suspension diagnosis.

FIG. 3 illustrates a graphical representation of a roll angle of the vehicle of FIG. 1 compared to torque applied.

FIG. 4 illustrates a graphical representation of a dynamic response of the roll angle of the vehicle of FIG. 1 being dampened by the vehicle suspension.

FIG. 5 illustrates a graphical representation of a Fast Fourier Transform (FFT) based on output from an inertial movement unit (IMU).

### DETAILED DESCRIPTION

Those having ordinary skill in the art will recognize that terms such as “above,” “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps.

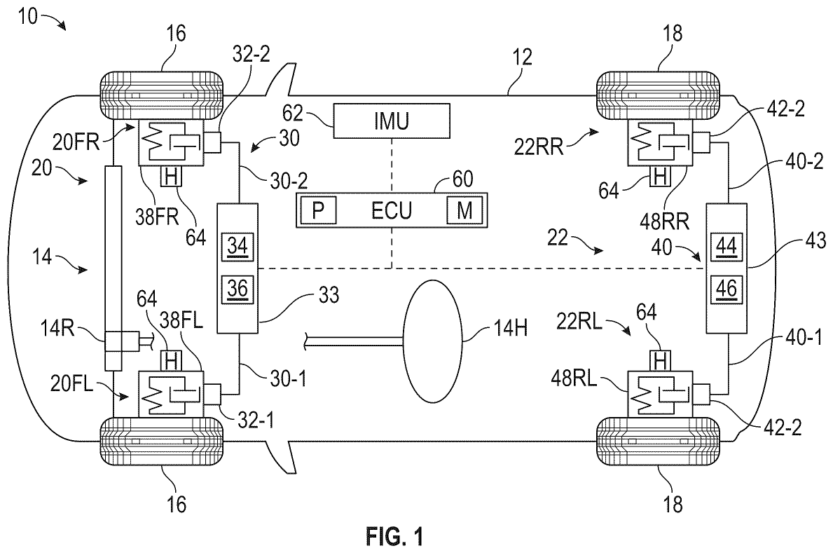

FIG. 1 illustrates an example of a vehicle 10 including a body 12 defining a passenger cabin supported by a pair of front wheels 16 and a pair of rear wheels 18. A steering system 14 includes a hand wheel 14H configured to create a road angle with the pair of front wheels 16 to selectively maneuver the vehicle 10 in a desired direction through a steering rack 14R. The pair of front wheels 16 are mechanically connected to a front axle suspension 20 having a front left corner suspension 20FL and a front right corner suspension 20FR. The pair of rear wheels 18 are mechanically connected to a rear axle suspension 22 having a rear left corner suspension 22RL and a rear right corner suspension 22RR. In this disclosure, the front axle suspension 20 and the rear axle suspension 22 can include an independent suspension or a live-axle suspension, depending on the type of vehicle 10.

The front axle suspension 20 includes a first active roll bar 30 having a first portion 30-1 attached to the front left corner suspension 20FL with a first end link 32-1 and a second portion 30-2 attached to the front right corner suspension 20FR with a second end link 32-2. The first and second portions 30-1 and 30-2 are mechanically linked with an actuator 33 having a gear box 34 driven by at least one drive motor 36 that allows the first and second portions 30-1 and 30-2 to move or rotate independently from each other. This allows the vehicle 10 to actively control the front axle suspension 20 during vehicle roll scenarios, as discussed in greater detail below.

The front left suspension corner 20FL include a front left suspension component 38FL that couples the sprung mass of the vehicle body 12 to an unsprung mass including a corresponding one of the pair of front wheels 16. The front right suspension corner 20FR includes a front right suspension component 38FR that couples the unsprung mass of the vehicle body 12 to a corresponding one of the pair of front wheels 16. The left and right suspension components 38FL and 38FR include a spring rate and provide a damping. In this disclosure, the left and right suspension components 38FL and 38FR can include at least one of a shock and spring, a strut, a hydraulic actuator, or other combinations of suspension components that provide a spring rate and damping. In particular, this disclosure applies to hydraulic actuators that can raise or lower opposite sides of the vehicle 10, as discussed in greater detail below.

The rear axle suspension 22 includes a second active roll bar 40 having a first portion 40-1 attached to the rear left corner suspension 22RL with a first end link 42-1 and a second portion 40-2 attached to the rear right corner suspension 22RR with a second end link 42-2. The first and second portions 40-1 and 40-2 are mechanically linked with an actuator 43 having a gear box 44 driven by at least one drive motor 46 that allows the first and second portions 40-1 and 40-2 to move or rotate independently from each other. This allows the vehicle 10 to actively control the roll of the rear axle suspension 22 during vehicle roll scenarios, as discussed in greater detail below.

The rear left suspension corner 22RL includes a rear right suspension component 48RL that couples the sprung mass of the vehicle body 12 to an unsprung mass including a corresponding one of the pair of rear wheels 18. The rear right suspension corner 22RR includes a rear right suspension component 48RR that couples the unsprung mass of the vehicle body 12 to a corresponding one of the pair of rear wheels 18. The rear left and right suspension components 48RL and 48RR include a spring rate and provide a damping. In this disclosure, the left and right suspension components 48RL and 48RR can include at least one of a shock and spring, a strut, a hydraulic actuator, or other combinations of suspension components that provide a spring rate and damping. In particular, this disclosure applies to hydraulic actuators that can raise or lower opposite sides of the vehicle 10, as discussed in greater detail below.

The vehicle 10 includes an ECU 60 that controls various operations on the vehicle, including actuating the drive motors 36 or 46 on the front and rear active roll bars 30 or 40, respectively, to control roll of the body 12 during operation of the vehicle 10. The ECU 60 is also in electrical communication with an inertial movement unit (IMU) 62 and the ride height sensors 64 at each corner of the vehicle 10 to measure a change in suspension height for each of the suspension corners of the vehicle 10 separately.

In this disclosure, the ECU 60 may be equipped with one or more processors (P), such as logic circuits, combinational logic circuit(s), Application Specific Integrated Circuit(s) (ASIC), electronic circuit(s), central processing unit(s), semiconductor IC devices, and others, along with input/output (I/O) circuit(s), appropriate signal conditioning and buffer circuitry, and additional components like a high-speed clock. The ECU 60 also includes a non-transitory computer-readable storage medium, i.e., memory (M) encompassing read-only memory, programmable read-only memory, random access memory, hard drives, and so forth, whether resident, remote, or a combination of both. The memory M can contain instructions for executing the method 100 discussed below.

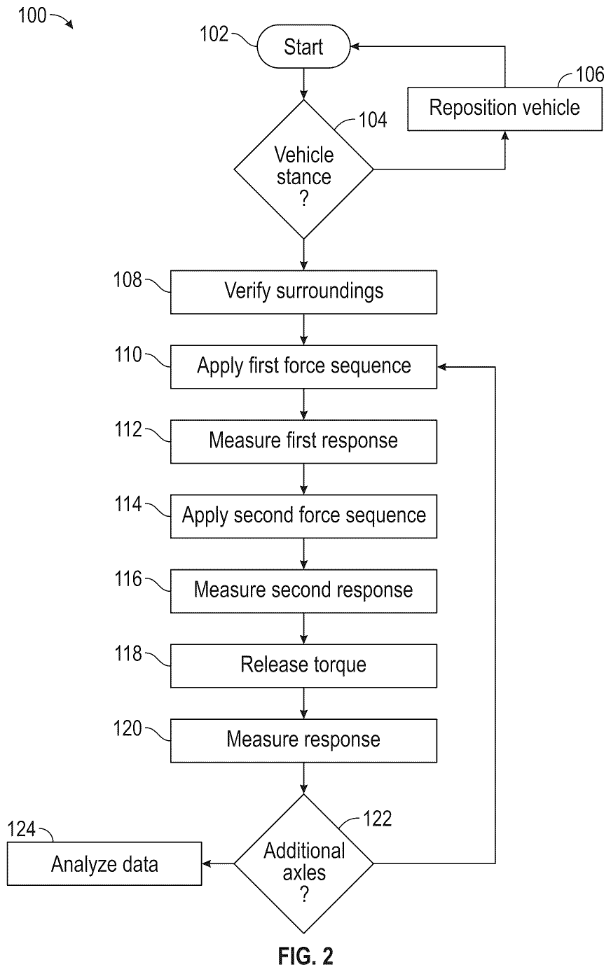

FIG. 2 illustrates an example method 100 of performing a suspension diagnosis on the vehicle 10. The method 100 begins at block 102 (“Start”). In one example, the method 100 beings when the vehicle 10 is placed in a diagnosis mode by a technician performing the suspension diagnosis on the vehicle 10. When the vehicle 10 is placed in the diagnosis mode, the drivability of the vehicle 10 may be limited until the suspension diagnosis is completed and the vehicle 10 is taken out of the diagnosis mode. Once the suspension diagnosis begins at block 102, the method 100 then proceeds to block 104.

At block 104 (“Vehicle Stance?”), the method 100 determines if the stance of the vehicle 10 is within a predetermined range of values. For example, the method 100 can utilize the IMU 62 to determine if an incline and tilt of the vehicle 10 is within a predetermined range of acceptable values. One feature of ensuring that the stance of the vehicle 10 is within the predetermined range of acceptable values is to ensure that a common starting point is obtained for analyzing the measurements obtained as discussed in greater detail below. This improves the reliability of the diagnosis by maintaining the vehicle 10 level for comparing actual vehicle movements to predicted vehicle movements. Additionally, the technician can confirm that there are not any loose items in the vehicle 10, such as a spare tire, and that the full tank is full to maintain commonality between the tests.

If the vehicle stance is not within the predetermined range of values, the method 100 proceeds to block 106 (“Reposition Vehicle”) and instructs the technician to reposition the vehicle 10 to ensure that the tilt and incline are within the predetermined range of acceptable values. The method 100 can then reverify the vehicle stance in the new location at block 104. If the vehicle stance is within the predetermined range of acceptable values, the method 100 proceeds to block 108.

At block 108 (“Verify Surroundings”), the method 100 requests the technician performing the suspension diagnosis to verify that the vehicle 10 is spaced from other objects, such as other vehicles or people, by at least a predetermined distance. When the technician confirms that the vehicle 10 is spaced from other objects or people by the predetermined distance, the method 100 proceeds to block 110.

At block 110 (“Apply First Force Sequence”), the method 100 applies opposing forces to the corners of the suspension being diagnosed, such as the front axle suspension 20 or the rear axle suspension 22. In this disclosure, the suspension corresponding to each axle on the vehicle is tested one at a time. One feature of testing in this manner is to avoid counteracting forces being applied between the axles on the vehicle 10. In one example, the first force sequence is applied to suspension being diagnosed utilizing a corresponding one of the active roll bars 30 or 40. The method 100 applies the first force sequence with the front or rear active roll bars 30, 40 by sending control signals with the controller 60 to the drive motors 36, 46 to rotate the first portion 30-1 or 40-1 in opposite directions from the second position 30-2 or 40-2, respectively, for the given suspension begin tested. This creates opposing forces between the suspension corners. The first force sequence includes a first time period where the force increases before reaching a maximum force at each of the opposing suspension corners that is opposite in direction.

In another example, the first force sequence is applied to either the front and rear axle suspensions 20 and 22 utilizing hydraulic actuators as the suspension components 38 and 48, respectively. The hydraulic actuators raise one of the suspension corners while lowering the other suspension corner for the suspension being diagnosed to create opposing forces between the suspension corners on either the front or rear axle suspension 20 or 22. When the first force sequence is completed, the method 100 proceeds to block 112.

At block 112 (“Measure First Response”), the method 100 analyzes data from the sensors, such as the ride height sensors 64 associated with the axle being diagnosed or the IMU 62, on the vehicle 10 while the first force sequence was being applied and is fully applied. One feature of the IMU 62 is that it measure an amount of roll the vehicle 10 experiences during the first force sequence in addition to changes in lateral acceleration of the vehicle 10 while the first force sequence is being applied.

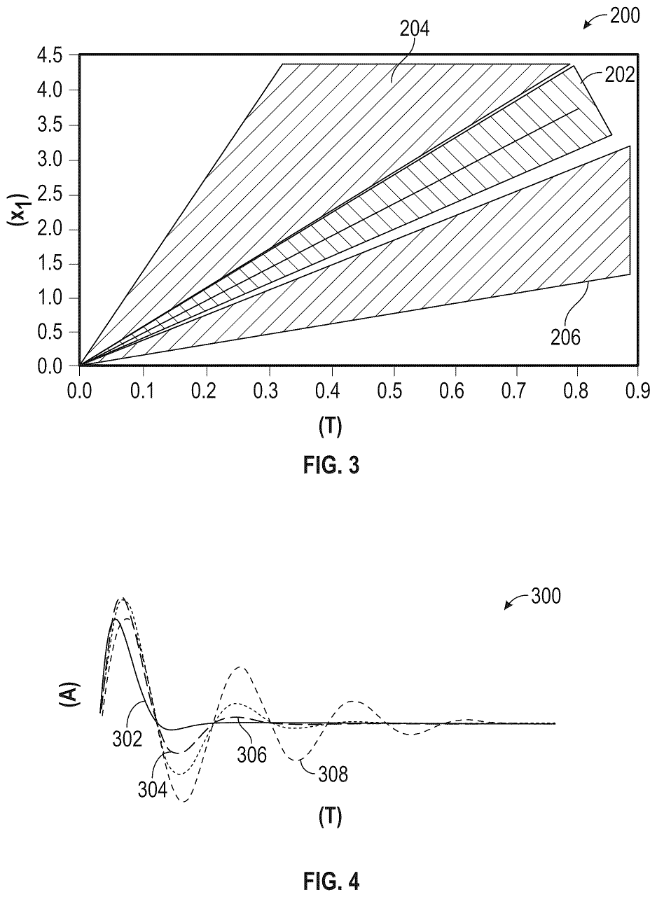

FIG. 3 is a graphical representation 200 of vehicle roll angel as measured by the IMU 62 with respect to input torque applied during the first force sequence. The x-axis of the graphical representation 200 includes torque (τ) and the y-axis includes roll angle (≮) in degrees. The graphical representation includes a first region 202 having an acceptable gradient for the roll angle compared to the input torque, a second area 204 having an exceeded gradient limit and a third region 206 where the input torque produced an insufficient roll angle. When the results are in the first region 202, this can indicate that a suspension component is broken, such as a spring and when the results are in the third region, this can indicate a broken end link 32. With the response measured, the method 100 proceeds to block 114.

At block 114 (“Apply Second Force Sequence”), a second force sequence is applied to the suspension being diagnosed. In one example, the second force sequence is applied to the suspension being diagnosed utilizing a corresponding one of the active roll bars 30 or 40. The method 100 applies the second force sequence with the front or rear active roll bars 30, 40 by sending control signals from the controller 60 to the drive motors 36 or 46 to rotate the first portions 30-1 or 40-1 in opposite directions from the second positions 30-2 or 40-2, respectively. This creates opposing forces between suspension corners. The second force sequence includes a second time period where the force increases before reaching a maximum force at each of the opposing suspension corners that is opposite in direction from the first force sequence. The method 100 then proceeds to block 116.

At block 116 (“Measure Second Response”), the method 100 analyzes data from the sensors, such as the ride height sensors 64 associated with the axle being diagnosed or the IMU 62, on the vehicle 10 while the second force sequence was being applied or is fully applied. As discussed above with respect to block 112, one feature of the IMU 62 is that it measures an amount of roll the vehicle 10 experiences during the second force sequence in addition to changes in lateral acceleration of the vehicle 10 while the second force sequence in addition to changes in lateral acceleration of the vehicle 10 while the first force sequence is being applied. With the second response measured, the method 100 proceeds to block 118.

At block 118 (“Release Torque”), the method 100 instructs the components applying the second force sequence to release the torque, such as releasing the torque to zero within a predetermined time. This allows the vehicle 10 to experience a dynamic response. The method 100 then proceeds to block 120.

At block 120 (“Measure Dynamic Response”), the method 100 measures a dynamic response after the torque is released at block 118 and the vehicle 10 is transitioning to a steady state condition. The dynamic response is measured when the maximum force applied under either the first force sequence or the second force sequence is released such that the suspension on the vehicle 10 returns to a steady state. The dynamic response can also be measured after the first force sequence is released as part of block 112. In this situation, the at least one sensor, such as the IMU 62, measures changes in roll on the vehicle 10 until the changes in the vehicle 10 are damped out to a steady state.

FIG. 4 illustrates a graphical representation 300 of roll angle (≮) for the vehicle 10 along the y-axis and time (t) on the x-axis. FIG. 4 illustrates four possible responses. Line 302 represents a response where the vehicle dampers, such as shocks, are new and quickly dampen the changes in vehicle roll angle. Line 304 represents a response where the dampers on the vehicle are damaged, such as leaking fluid. Line 306 represents a response where the dampers on the vehicle 10 are approximately 25% worn and allow a greater amount of vehicle roll than the first line 302. Line 308 represents a response where the dampers on the vehicle 10 having reached their operating lifespan and require replacement.

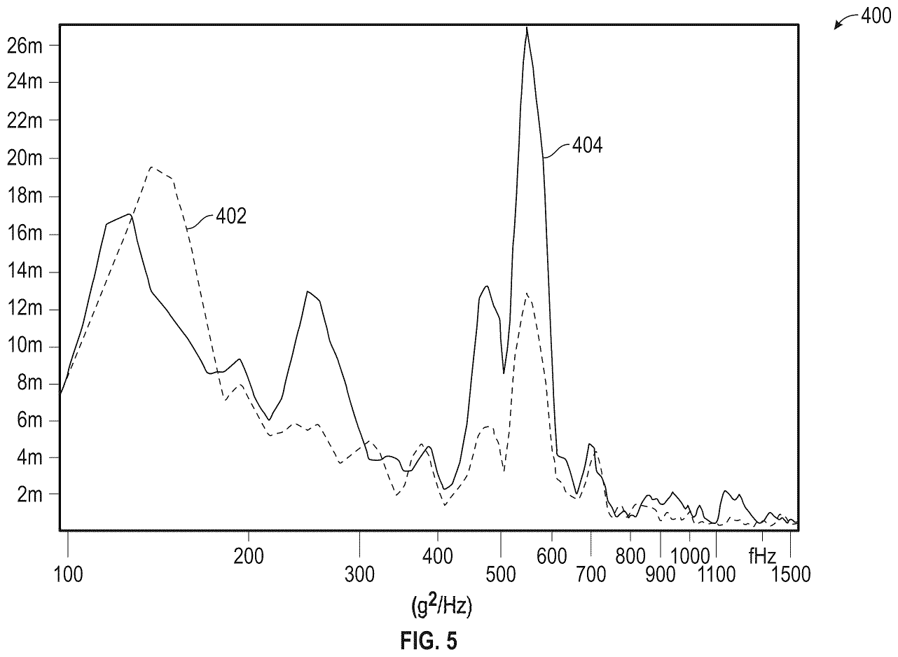

FIG. 5 illustrates a graphical representation 400 with a Fast Fourier Transform (FFT) converting time domain signals from the IMU 62 to a frequency domain. In the graphical representation 400, frequency is along the x-axis and g²/Hz along the y-axis, where g represents acceleration reference to gravity. This allows normal suspension behavior with line 402 to be compared with behavior of a damaged suspension component with line 404. As shown in FIG. 5, the spike in line 404 indicates a loose or worn link in the suspension being diagnosed. With the dynamic response measured, the method 100 proceeds to block 122.

At block 122 (“Additional Axles?”), the method 100 determines if there are additional suspension assemblies on the vehicle 10 to test. In the illustrated example, the vehicle 10 includes the front suspension 20 and the rear suspension 22, but this disclosure applies to vehicles 10 having more than a single front and rear suspension. Therefore, if one of the suspensions on the vehicle 10 has not been analyzed, the method 100 can return to blocks 110-118 to analyze any additional suspensions on the vehicle 10. If the method 100 determines that there are not any additional suspensions on the vehicle 10 that need to be analyzed, the method 100 then proceeds to block 124.

At block 124 (“Analyze Data”), the method 100 analyzes data associated with the first response, the second response, and the dynamic response for each axle to determine a status of each suspension on the vehicle 10. If data associated with the first response or the second response for either of the suspensions tested indicates that suspension travel is less than a predetermined threshold value, it could indicate that an end link 32-1, 32-2, 42-1, or 42-2 is broken when utilizing an active roll bar for the first force sequence or the second force sequence. In particular, if one of the end links 32-1, 32-2, 42-1, or 42-2 are broken, the force applied by the active roll bar 30 or 40 would not be transferred into the suspension because of the broken link.

Also, if the dynamic response includes damping less than a predetermined threshold as discussed above with respect to FIG. 4, it could indicate that a suspension damper has failed or is about to fail. If the roll of the vehicle 10 measured by the IMU 62 includes a damping less than a predetermined threshold, then the dampers on the vehicle 10 may need to be replaced.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure is not limited to the particular embodiments disclosed but will include embodiments falling within the scope thereof.

What is claimed is:

1. A method of diagnosing a suspension on a vehicle, the method comprising:
applying a first force sequence across a first axle suspension;
measuring a first response of the first axle suspension to the first force sequence using at least one sensor on the vehicle;
applying a second force sequence across the first axle suspension;
measuring a second response of the first axle suspension to the second force sequence using the at least one sensor on the vehicle;
measuring a dynamic response of the first axle suspension when one of the first force sequence or the second force sequence is released; and
determining a status of the first axle suspension based on at least one of the first response, the second response, or the dynamic response.

2. The method of claim 1, wherein the first force sequence is applied utilizing an active roll bar applying a first pair of opposing forces to the first axle suspension in a first pair of rotational directions.

3. The method of claim 2, wherein the second force sequence is applied utilizing the active roll bar applying a second pair of opposing forces to the first axle suspension in a second pair of rotational directions opposite the first pair of rotational directions.

4. The method of claim 3, wherein the active roll bar includes a drive motor configured to rotate a first portion of the active roll bar independently of a second portion of the active roll bar.

5. The method of claim 4, wherein the first portion of the active roll bar is mechanically connected to a first suspension corner of the first axle suspension with a first end link and the second portion of the active roll bar is connected to a second corner of the first axle suspension with a second end link.

6. The method of claim 1, wherein the first force sequence and the second force sequence are applied utilizing a first pair of hydraulic actuators each mechanically connected to opposing corners of the first axle suspension.

7. The method of claim 1, wherein the dynamic response includes a first dynamic response when the first force sequence is released and a second dynamic response when the second force sequence is released.

8. The method of claim 1, wherein the at least one sensor includes a pair of ride height sensors configured to measure suspension travel on opposing corners of the first axle suspension.

9. The method of claim 8, including identifying a broken end link when suspension travel measured with the at least one sensor is less than a predetermined suspension travel.

10. The method of claim 1, wherein the at least one sensor includes an inertial measurement unit configured to measure a roll angle of the vehicle and a lateral acceleration of the vehicle.

11. The method of claim 10, including identifying a worn damper when the lateral acceleration damping of the vehicle is below a predetermined damping threshold.

12. The method of claim 10, wherein the status includes is determined to be a non-functioning suspension component when a lateral acceleration peak exceeds a predetermined lateral acceleration threshold peak.

13. A non-transitory computer-readable storage medium embodying programmed instructions which, when executed by a processor, are operable for performing a method comprising:
applying a first force sequence across a first axle suspension on a vehicle;
measuring a first response of the first axle suspension to the first force sequence using at least one sensor on the vehicle;
applying a second force sequence across the first axle suspension;
measuring a second response of the first axle suspension to the second force sequence using the at least one sensor on the vehicle;
measuring a dynamic response of the first axle suspension when one of the first force sequence or the second force sequence is released; and
determining a status of the first axle suspension based on at least one of the first response, the second response, or the dynamic response.

14. The non-transitory computer-readable storage medium of claim 13, wherein the first force sequence is applied utilizing an active roll bar applying a first pair of opposing forces to the first axle suspension in a first pair of rotational directions.

15. The non-transitory computer-readable storage medium of claim 14, wherein the second force sequence is applied utilizing the active roll bar applying a second pair of opposing forces to the first axle suspension in a second pair of rotational directions opposite the first pair of rotational directions.

16. The non-transitory computer-readable storage medium of claim 15, wherein the active roll bar includes a drive motor configured to rotate a first portion of the active roll bar independently of a second portion of the active roll bar and the first portion of the active roll bar is mechanically connected to a first suspension corner of the first axle suspension with a first end link and the second portion of the active roll bar is connected to a second corner of the first axle suspension with a second end link.

17. A vehicle comprising:
a body defining a passenger cabin;
a first suspension corresponding to a first axle and configured to support the body;
a second suspension corresponding to a second axle and configured to support the body;
a first suspension actuator associated with the first axle;
a second suspension actuator associated with the second axle;
at least one sensor configured to measure movement of the first axle, the second axle, or the body;
a controller in communication with the first suspension actuator, the second suspension actuator, and the at least one sensor, wherein the controller is configured to:
apply a first force sequence across a first axle suspension;
measure a first response of the first axle suspension to the first force sequence with at least one sensor on the vehicle;
apply a second force sequence across the first axle suspension;
measure a second response of the first axle suspension to the second force sequence using the at least one sensor on the vehicle;
measure a dynamic response of the first axle suspension when one of the first force sequence or the second force sequence is released; and
determine a status of the first axle suspension based on at least one of the first response, the second response, or the dynamic response.

18. The vehicle of claim 17, wherein the first force sequence is applied utilizing an active roll bar applying a first pair of opposing forces to the first axle suspension in a first pair of rotational directions.

19. The vehicle of claim 18, wherein the second force sequence is applied utilizing the active roll bar applying a second pair of opposing forces to the first axle suspension in a second pair of rotational directions opposite the first pair of rotational directions.

20. The vehicle of claim 19, wherein the active roll bar includes a drive motor configured to rotate a first portion of the active roll bar independently of a second portion of the active roll bar and the first portion of the active roll bar is mechanically connected to a first suspension corner of the first axle suspension with a first end link and the second portion of the active roll bar is connected to a second corner of the first axle suspension with a second end link.
